(19) United States
(12) Patent Application Publication
(10) Pub. No.: US 2011/0273890 A1
(43) Pub. Date: Nov. 10, 2011

(54) VENTILATED LED OPTICS

(76) Inventor: SCOTT RIESEBOSCH, St. Catharines (CA)

(21) Appl. No.: 13/103,456

(22) Filed: May 9, 2011

Related U.S. Application Data
(60) Provisional application No. 61/333,043, filed on May 10, 2010.

(51) Int. Cl. F21V 29/00

(52) U.S. Cl. 362/294

(57) ABSTRACT

In accordance with certain embodiments, an illumination device includes a light-emitting diode and a light-guiding optical component comprising a channel therethrough.

### RELATED APPLICATION

This application claims the benefit of and priority to U.S. Provisional Patent Application No. 61/333,043, filed May 10, 2010, the entire disclosure of which is hereby incorporated herein by reference.

### FIELD OF THE INVENTION

The present invention generally relates to optics for lighting systems, and more specifically to optics facilitating thermal dissipation.

### BACKGROUND

Discrete light sources such as light-emitting diodes (LEDs) are an attractive alternative to incandescent light bulbs in illumination devices due to their smaller form factor, longer lifetime, and enhanced mechanical robustness. For a wide variety of lighting applications, the light from one or more LEDs is frequently diffused and directed by optics such as total-internal-reflection (TIR) optics. Thus, even though LEDs are effectively omnidirectional point sources of light, the light from LEDs may be propagated through a large area and/or in specific directions.

Traditionally, optical engineers have designed lenses to obtain a desired illumination pattern from an LED or LED system. Lenses, however, can only collect light within their diameters; light outside the diameter of lens is lost, resulting in the need for further optics to capture such light. TIR optics utilize the principle of total internal reflection—whereby light is reflected at the boundary (or boundaries) of the optic and retained therein—and typically encompass the entire light source, thereby reducing or eliminating optical loss.

However, the utilization of optics such as TIR optics for LEDs is not without its drawbacks. In addition to light, LEDs typically generate heat during operation, and increased operating temperatures may have negative impacts on the lifetime and/or performance of the LEDs. Furthermore, any light scattered back to the LED by a TIR optic may generate additional heat as it is absorbed by the LED, exacerbating these thermal reliability issues. Since the small form factor of LEDs causes heat to be concentrated in a small area (smaller than, e.g., the surface area of a typical incandescent light bulb), there is a need for methods of cooling and ventilation that facilitate the reliable functioning of illumination devices based on solid-state light sources such as LEDs.

### SUMMARY

In accordance with certain embodiments, LED-based illumination devices having ventilated optics are provided. Each optic may be associated with one or more LEDs and contains at least one channel extending therethrough. The channel(s) facilitate the flow of air around and/or past the LED, cooling the LED and substantially eliminating pockets of “dead” (i.e., stagnant or uncirculating) air near the LED. In this manner, deleterious increases in the LED's operating temperature are avoided and the lifetime and reliability of the LED are enhanced.

In an aspect, embodiments of the invention feature an illumination device including or consisting essentially of a light-emitting diode and a light-guiding optical component disposed over the light-emitting diode for propagating and directing light from the light-emitting diode. The optical component includes a channel therethrough fluidly connecting the light-emitting diode proximate one end of the channel to an outside ambient at the other end of the channel.

Embodiments of the invention may include one or more of the following, in any of a variety of combinations. The optical component may be a total-internal-reflection optic. At least a portion of light emitted by the light-emitting diode may propagate directly through the channel without reflection or refraction. At least a portion of light emitted by the light-emitting diode may propagate through the channel via total internal reflection. The non-channel portion of the optical component may conduct, with total internal reflection, at least a portion of light emitted by the light-emitting diode to the emission surface of the optical component opposite the light-emitting diode. Heat produced by the light-emitting diode may convect through the channel into the surrounding ambient. Air drawn in from the surrounding ambient through the channel may convect heat produced by the light-emitting diode. The optical component may be substantially optically transparent.

The light-emitting diode may be disposed within a cavity in the optical component, and the cavity may have a cross-sectional area larger than the cross-sectional area of the channel. The cavity may include, between the light-emitting diode and the optical component, a gap for enabling flow of air past the light-emitting diode to the surrounding ambient through the channel. The channel may flare outwardly from one end to the other end. At least portions of the light-emitting diode and the optical component may be disposed within a housing. The housing may include a threaded base compatible with an incandescent light fixture (i.e., a fixture for incandescent light bulbs). A diffusive cover may be disposed over at least a portion of the optical component. At least one additional light-emitting diode and associated additional optical component may be disposed in the housing, and the optical component and the additional optical component may direct light out of the housing in substantially the same direction.

In another aspect, embodiments of the invention feature a method of illumination. Simultaneously, from a light source (e.g., one or more light-emitting diodes) and in an emission direction, a first light portion is propagated through a light-guiding optic, and a second light portion (i.e., different from the first light portion) is propagated through free space.

Embodiments of the invention may include one or more of the following, in any of a variety of combinations. The first light portion may be refracted or reflected within the light-guiding optic. The first and/or second light portions may be diffused prior to being propagated to the surrounding ambient. Heat from the light source may be convected through the free space through which the second light portion is emitted. Air may be conducted through the free space through which the second light portion is emitted, thereby convecting heat from the light source. The free space through which the second light portion is propagated may include or consist essentially of a channel through the light-guiding optic. The light-guiding optic may include or consist essentially of a total-internal-reflection optic.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. As used herein, the term “substantially” means±10%, and in some embodiments, ±5%.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic illustration of a prior-art illumination device incorporating an optic;

FIG. 2 is a schematic illustration of an illumination device having an optic with a channel therethrough, in accordance with various embodiments of the invention; and

FIGS. 3, 4, and 5 are, respectively, a perspective view, a front view, and a cross-sectional schematic view of an illumination system in accordance with various embodiments of the invention.

### DETAILED DESCRIPTION

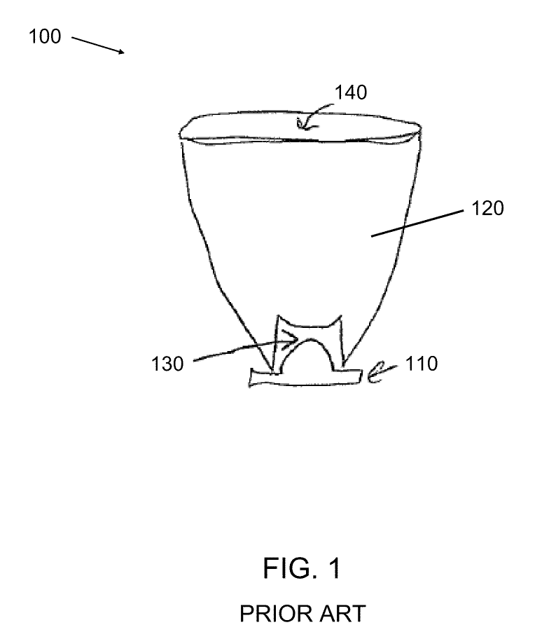

FIG. 1 depicts a prior-art illumination device 100 that includes an LED 110 and an optic 120. The LED is typically a packaged LED that includes the LED chip, associated electronics, and a package featuring a lens surrounding the chip. Optic 120 includes a cavity 130 into which the LED 110 is positioned such that substantially all of the light emitted by LED 110 propagates into optic 120 and is confined therein until emerging out its top surface 140. Problematically, air is generally trapped inside cavity 130 between LED 110 and optic 120. During operation of LED 110, the temperature of LED 110 and the trapped air increase dramatically, since air flow out of cavity 130 is difficult or impossible, and the lifetime and reliability of LED 110 are negatively impacted.

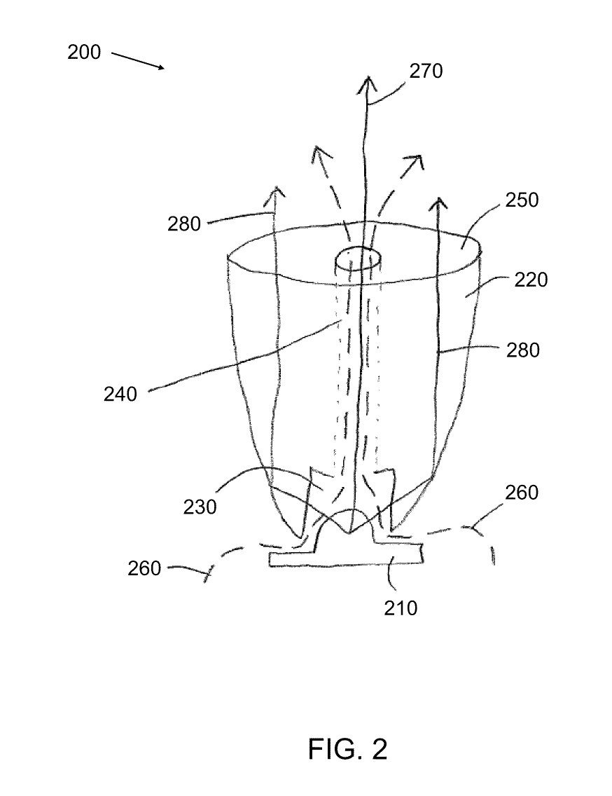

FIG. 2 depicts an illumination device 200 in accordance with embodiments of the present invention. Illumination device 200 includes a discrete light source 210 (interchangeably referred to herein as LED 210), which may be one or more packaged LEDs, bare LED chips, LED chips each capped with one or more lenses, packaged or bare laser chips, and/or other solid-state light sources. LED 210 may even include a plurality of any of the foregoing examples together in a single package. LED 210 may emit substantially white light; for example, LED 210 may have a colored output that mixes with a phosphor to produce a white output or may be a combination of colored LEDs (e.g., red, green, and blue) whose emitted light mixes to form substantially white light. In other embodiments, LED 210 emits non-white light, e.g., red, amber, blue, or green light.

An optic 220 is disposed over LED 210; typically, LED 210 is positioned within a cavity 230 formed by a surface of optic 220. Optic 220 may be a TIR optic, is generally solid (i.e., not hollow except for the presence of one or more channels therewithin, as described below), and may include or consist essentially of a substantially transparent polymeric material (e.g., polycarbonate). Preferably, optic 220 is not completely sealed to LED 210. Rather, there is preferably at least one opening or gap therebetween to facilitate airflow around and/or past LED 210 (as detailed below). The gap may be created by posts or other spacers (not shown) that elevate optic 220 above LED 210, or, depending on the design of the illumination system, by the larger fixture retaining both the optic 220 and the LED 210.

Optic 220 advantageously features at least one channel 240 that extends through optic 220 from cavity 230 to a top surface 250. Channel 240 enables the flow of air (or another cooling fluid) past LED 210 through optic 220 and into the surrounding ambient (or vice versa). This convection airflow 260 (depicted in FIG. 2 as arrows) draws heat away from LED 210 during operation, thus maintaining LED 210 at a lower temperature and enhancing its lifetime and reliability. Although airflow 260 is depicted as flowing upward from LED 210 through channel 240, it may alternatively or additionally flow in the opposite direction. Airflow 260 may result from natural convection and/or may be driven by one or more active cooling mechanisms such as fans (not shown). During operation of illumination device 200, the temperature of LED 210 may be between approximately 1° C. and approximately 5° C. cooler due to the presence of channel 240. In preferred embodiments, channel 240 has a smaller cross-sectional area than that of cavity 230, and no portion of LED 210 is disposed within channel 240. Furthermore, preferably (but not necessarily) substantially all of optic 220 is optically transparent, e.g., no reflective or mirror coatings are present on optic 220.

In addition to facilitating the cooling of LED 210, optic 220 enables more efficient light extraction from LED 210 than an optic without channel 240 (such as optic 120). With such prior-art optics, all of the light emitted by the LED must pass through the optic to be directed into the outside ambient. Some light may lost in such a process (e.g., due to reflection), decreasing the overall efficiency of the illumination device. In contrast, a portion 270 of the light emitted by LED 210 travels directly through channel 240 rather than the bulk of optic 220, increasing the efficiency of illumination device 200. Since channel 240 preferably defines a direct line-of-sight between LED 210 and the emission surface of optic 220 opposite LED 210, portion 270 of the light emitted by LED 210 travels through channel 240 without reflection or refraction, and another portion of the light (not shown) typically also propagates through channel 240 via internal reflection from the inner surface of channel 240. Additional light 280 (e.g., light emitted non-vertically in the arrangement of FIG. 2) enters optic 220 and is emitted therefrom as it would from optic 120. The extraction efficiency may increase (compared to an illumination device having an optic without channel 240) by between approximately 1% and approximately 5%.

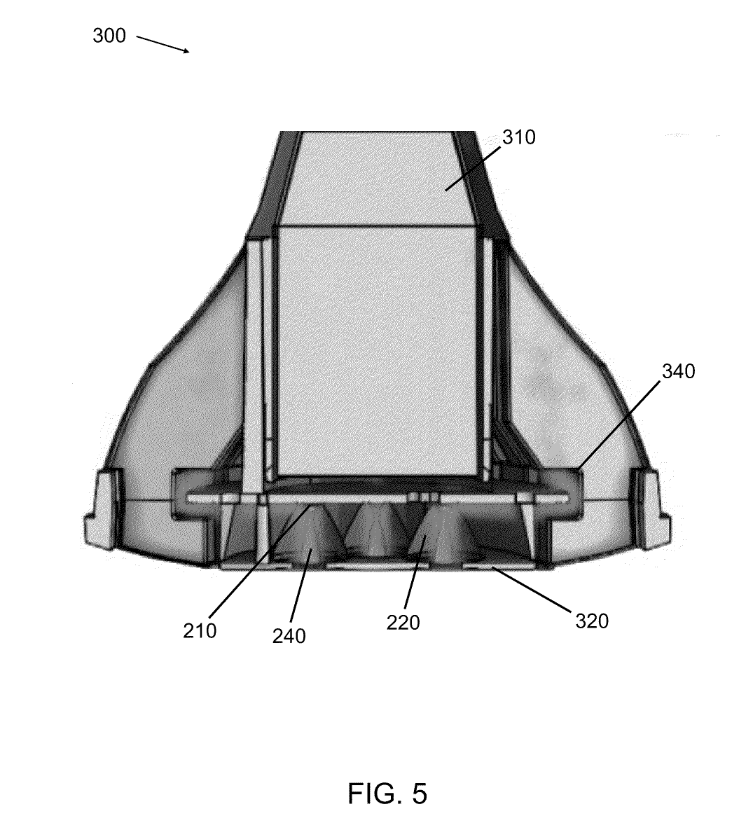

Although channel 240 is depicted as cylindrical in shape with a substantially smooth wall, the cross-section of channel 240 may have other shapes and may be nonuniform through its length. For example, channel 240 may flare outward at one or both ends (as shown in FIG. 5). Moreover, there may be more than one channel 240 arranged in a pattern designed to balance the need for airflow against degradation of optical performance. Other configurations are possible and are encompassed by embodiments of the present invention. Furthermore, channel 240 may be utilized in conjunction with or instead of other ventilation paths that may be present in LED-based illumination devices (e.g., in the surrounding opaque housings of such devices).

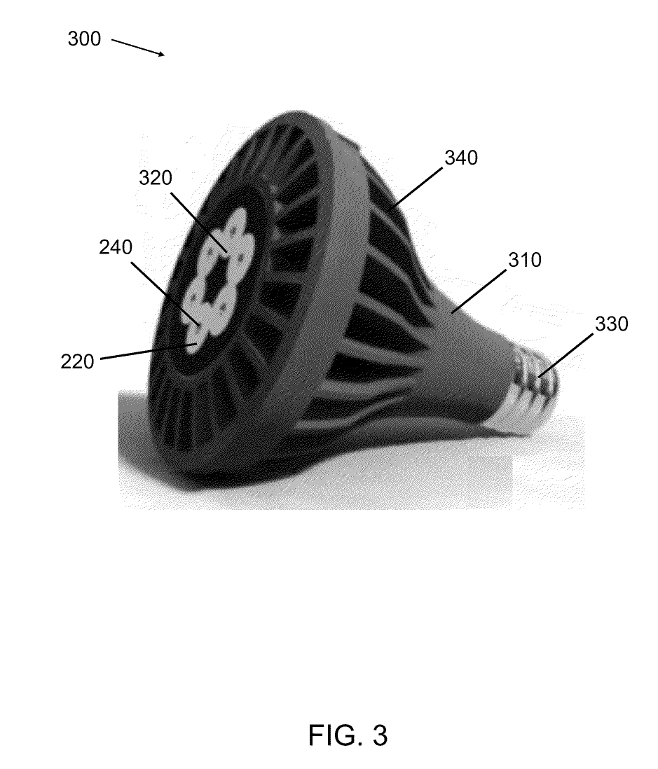

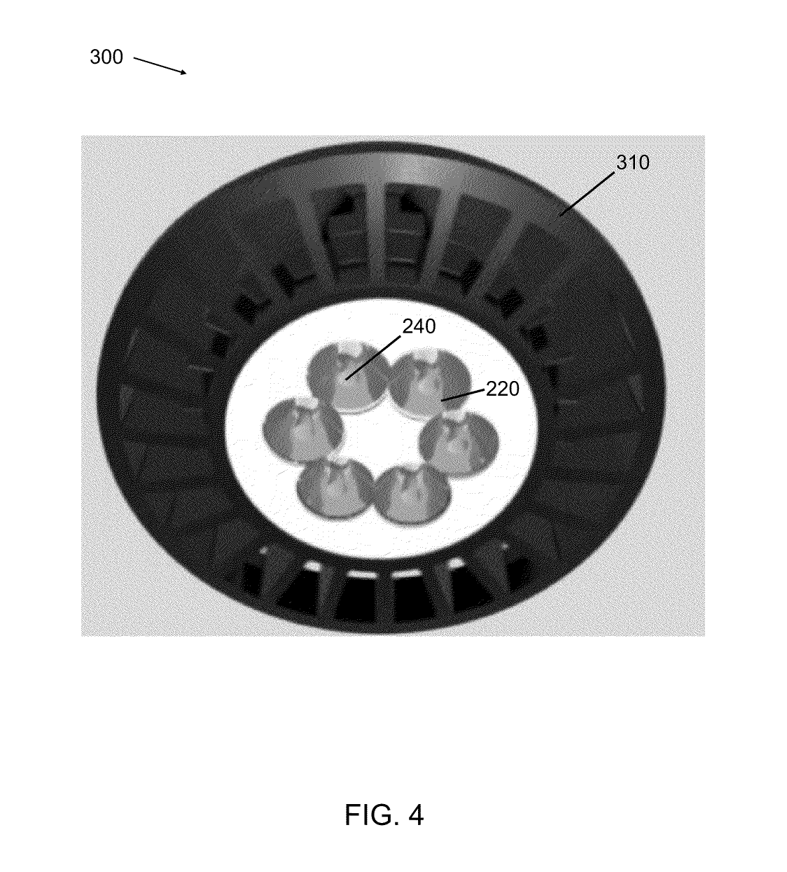

Embodiments of the present invention may be utilized in a variety of illumination systems. For example, FIGS. 3-5 depict an illumination system 300 incorporating six LEDs 210, each with an associated optic 220, disposed in a housing 310. Each optic 220 contains a channel 240, as detailed above, and may be covered with a diffusive cover 320 (not shown in FIG. 4). Diffusive cover 320 may be disposed over only the channel 240 of an optic 220, the entire top surface of the optic 220 including the channel 240, or over multiple (or even all) optics 220 in the illumination system. Preferably, at least in embodiments in which diffusive cover 320 is disposed over channel 240, diffusive cover 320 is not in direct contact with channel 240; rather, there is preferably a gap therebetween, thereby enabling air flow into and/or out of channel 240 as described herein. The gap may be created by posts or other spacers (not shown) that elevate diffusive cover 320 above channel 240, or, depending on the design of the illumination system, by the larger fixture retaining both the diffusive cover 320 and the channel 240. In some embodiments, diffusive cover 320 is disposed over portions of one or more optics 220 other than their channel(s) 240. The diffusive cover 320 may include or consist essentially of a substantially transparent or translucent material, e.g., a polymeric or plastic material, and may be textured (and/or incorporate a pattern of diffusive structures such as dots or hemispheres) in order to scatter and/or redirect light passing therethrough across a wider angle.

Housing 310 may have the form factor of an incandescent bulb (e.g., the floodlight shape depicted in FIGS. 3-5), e.g., a PAR form factor such as PAR-20, PAR-30, PAR-30S, PAR-30L, or PAR-38. Housing 310 typically also includes a threaded base 330 for compatibility with incandescent fixtures. Housing 310 may also include channels 340 therethrough that are in fluid connection with channels 240 of optics 220. Thus, air flowing into channels 240 may advantageously flow through channels 340 (or vice versa) and back into the surrounding ambient, dissipating heat along the way. Housing 310 may also house various electronic circuits for control of or power supply to LEDs 210, e.g., a dimmer, rectifier, and/or transformer, as well as electrical connections thereto. The electrical circuits incorporated within illumination system 200 or 300 may also include thermal foldback circuits such as those disclosed in U.S. patent application Ser. No. 12/881,764, filed Sep. 14, 2010 and/or U.S. patent application Ser. No. 13/092,445, filed Apr. 22, 2011, the entire disclosure of each of which is incorporated by reference herein. Such circuits may advantageously utilize and/or sample the temperature of one or more LEDs 210, optics 220, and/or of the air flow through one or more channels 240 or 340 in feedback-based control of the LEDs 210.

Illumination system 200 or 300 may be utilized as a replacement for one or more incandescent, halogen, or fluorescent light bulbs, particularly in applications and/or locations where heat dissipation (particularly lateral heat dissipation, i.e., perpendicular to the light-emission axis) is poor. Illumination system 200 or 300 may be utilized in systems utilizing solid-state and/or LED-based lighting, for example, the streetlight systems disclosed in U.S. patent application Ser. No. 12/977,901, filed Dec. 23, 2010, and/or the exterior illumination and/or emergency lighting systems disclosed in U.S. patent application Ser. No. 12/945,364, filed Nov. 12, 2010, the entire disclosure of each of which is incorporated by reference herein.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. An illumination device comprising:
a light-emitting diode; and
a light-guiding optical component disposed over the light-emitting diode for propagating and directing light therefrom, the optical component comprising a channel therethrough fluidly connecting the light-emitting diode proximate one end of the channel to an outside ambient at the other end of the channel.

2. The illumination device of claim 1, wherein the optical component is a total-internal-reflection optic.

3. The illumination device of claim 1, wherein at least a portion of light emitted by the light-emitting diode propagates directly through the channel without reflection or refraction.

4. The illumination device of claim 1, wherein at least a portion of light emitted by the light-emitting diode propagates through the channel via total internal reflection.

5. The illumination device of claim 1, wherein a non-channel portion of the optical component conducts, with total internal reflection, at least a portion of light emitted by the light-emitting diode to an emission surface of the optical component opposite the light-emitting diode.

6. The illumination device of claim 1, wherein heat produced by the light-emitting diode convects through the channel into the surrounding ambient.

7. The illumination device of claim 1, wherein air drawn in from the surrounding ambient through the channel convects heat produced by the light-emitting diode.

8. The illumination device of claim 1, wherein the optical component is substantially optically transparent.

9. The illumination device of claim 1, wherein the light-emitting diode is disposed within a cavity in the optical component, the cavity having a cross-sectional area larger than a cross-sectional area of the channel.

10. The illumination device of claim 9, wherein the cavity comprises, between the light-emitting diode and the optical component, a gap for enabling flow of air past the light-emitting diode to the surrounding ambient through the channel.

11. The illumination device of claim 1, wherein the channel flares outwardly from one end to the other end.

12. The illumination device of claim 1, further comprising a housing, wherein the light-emitting diode and the optical component are disposed within the housing.

13. The illumination device of claim 12, wherein the housing comprises at least one passage therethrough fluidly connected to the channel.

14. The illumination device of claim 12, wherein the housing comprises a threaded base compatible with an incandescent light fixture.

15. The illumination device of claim 12, further comprising a diffusive cover disposed over at least a portion of the optical component.

16. The illumination device of claim 12, further comprising at least one additional light-emitting diode and at least one additional optical component associated therewith disposed in the housing, the optical component and the at least one additional optical component directing light out of the housing in substantially the same direction.

17. A method of illumination, the method comprising:
simultaneously propagating, from a light source and in an emission direction:
a first light portion through a light-guiding optic; and
a second light portion through free space.

18. The method of claim 17, further comprising refracting or reflecting the first light portion within the light-guiding optic.

19. The method of claim 17, further comprising diffusing the first and second light portions prior to the first and second light portions propagating to a surrounding ambient.

20. The method of claim 17, further comprising convecting heat from the light source through the free space through which the second light portion is emitted.

21. The method of claim 17, further comprising conducting air through the free space through which the second light portion is emitted, thereby convecting heat from the light source.

22. The method of claim 17, wherein the free space through which the second light portion is propagated comprises a channel through the light-guiding optic.

23. The method of claim 17, wherein the light-guiding optic comprises a total-internal-reflection optic.
